(19) United States
(12) Patent Application Publication
(10) Pub. No.: US 2020/0298180 A1
(43) Pub. Date: Sep. 24, 2020

(54) MEMBRANE SEPARATION APPARATUS

(71) Applicant: MIURA CO., LTD., Matsuyama-shi Ehime (JP)

(72) Inventors: Yuji TAKASHIMA, Matsuyama-shi Ehime (JP); Hayato WATANABE, Matsuyama-shi Ehime (JP); Masaaki HIRAO, Matsuyama-shi Ehime (JP); Yoshihiko NAKA, Matsuyama-shi Ehime (JP)

(21) Appl. No.: 16/796,185

(22) Filed: Feb. 20, 2020

(30) Foreign Application Priority Data
Mar. 18, 2019 (JP) 2019-049892

(51) Int. Cl. B01D 61/02; C02F 1/44; B01D 61/12

(52) U.S. Cl. CPC B01D 61/025; C02F 1/441; C02F 2209/40; C02F 2209/02; C02F 2209/03; B01D 61/12

(57) ABSTRACT

A membrane separation apparatus includes: a pump controller to control a rotational speed of a booster pump; an intake water pressure regulation valve controller to control an opening degree of an intake water pressure regulation valve; a drainage water flowrate regulation valve controller to control an opening degree of a drainage water flowrate regulation valve; and a timing adjustor to adjust timings of control by the pump controller, the intake water pressure regulation valve controller, and the drainage water flowrate regulation valve controller. When water is supplied to the membrane separation apparatus, the timing adjustor provides time lags among a control start of the booster pump by the pump controller, a control start of the intake water pressure regulation valve by the intake water pressure regulation valve controller, and a control start of the drainage water flowrate regulation valve by the drainage water flowrate regulation valve controller.

This application is based on and claims the benefit of priority from Japanese Patent Application No. 2019-049892, filed on 18 Mar. 2019, the content of which is incorporated herein by reference.

### BACKGROUND OF THE INVENTION

### Field of the Invention

The present invention relates to a membrane separation apparatus.

### Related Art

In manufacturing processes of semiconductor and cleansing of electronic devices and medical instruments, for example, pure water of high purity containing no impurities has been used. In general, this kind of pure water is produced by subjecting raw water, such as groundwater and tap water, to reverse osmosis membrane separation processing in a reverse osmosis membrane module (hereinafter also referred to as “RO membrane module”).

A water permeability coefficient of a reverse osmosis membrane made of a high polymer varies in accordance with temperature. The water permeability coefficient of the reverse osmosis membrane also varies due to pore blocking (hereinafter also referred to as “membrane fouling”) and deterioration owing to material oxidation (hereinafter also referred to as “membrane deterioration”).

In view of this, to keep a flowrate of permeated water constant in the RO membrane module irrespective of temperature of the raw water and a state of the reverse osmosis membrane, a water quality improving system to perform flowrate feedback water-amount control has been proposed (see, for example, JP-A-2005-296945).

In this water quality improving system, a drainage water flowrate regulation valve to regulate a drainage water flowrate and a feedwater pressure regulation valve to regulate a feedwater pressure are employed, and inverter control is performed to control a permeated water flowrate. When control frequency of the drainage water flowrate regulation valve and the feedwater pressure regulation valve is increased, lives of the drainage water flowrate regulation valve and the feedwater pressure regulation valve are shortened. Follow-up control with respect to other PI control is frequently performed to make hunting more liable to occur.

### SUMMARY OF THE INVENTION

It is an object of the invention to provide a membrane separation apparatus that can lengthen lives of opening-degree adjustable valves and stabilize various kinds of PI control.

According to an aspect of the invention, a membrane separation apparatus includes a reverse osmosis membrane module, a booster pump, a pump controller, an intake water pressure regulation valve, a drainage water flowrate regulation valve, an intake water pressure regulation valve controller, a drainage water flowrate regulation valve controller, and a timing adjustor. The reverse osmosis membrane module is configured to separate feedwater including intake water into permeated water and concentrated water. The booster pump is configured to take in the intake water and discharge the intake water as the feedwater to the reverse osmosis membrane module. The pump controller is configured to control a rotational speed of the booster pump. The intake water pressure regulation valve has an opening degree substantially steplessly adjusted to regulate a pressure of the intake water supplied to the booster pump. The drainage water flowrate regulation valve has an opening degree substantially steplessly adjusted to regulate a drainage water flowrate of the concentrated water to be drained from the apparatus. The intake water pressure regulation valve controller is configured to control the opening degree of the intake water pressure regulation valve. The drainage water flowrate regulation valve controller is configured to control the opening degree of the drainage water flowrate regulation valve. The timing adjustor is configured to adjust timings of control by the pump controller, the intake water pressure regulation valve controller, and the drainage water flowrate regulation valve controller. At the time of supplying water to the membrane separation apparatus, the timing adjustor is configured to provide time lags among a control start timing of the booster pump by the pump controller, a control start timing of the intake water pressure regulation valve by the intake water pressure regulation valve controller, and a control start timing of the drainage water flowrate regulation valve by the drainage water flowrate regulation valve controller.

Preferably, at the time of supplying water to the membrane separation apparatus, after starting to control the intake water pressure regulation valve, the timing adjustor is configured to cause the pump controller to start to control the booster pump or configured to cause the drainage water flowrate regulation valve controller to control the drainage water flowrate regulation valve.

Preferably, at the time of supplying water to the membrane separation apparatus, the timing adjustor is configured to cause the pump controller to start to control the booster pump after starting to control the intake water pressure regulation valve, and configured to cause the drainage water flowrate regulation valve controller to control the drainage water flowrate regulation valve after starting to control the booster pump.

Preferably, the membrane separation apparatus further includes a pressure measurer configured to measure a pressure value of the intake water, and the intake water pressure regulation valve controller is configured to perform feedback control using the pressure value of the intake water as a feedback value.

Preferably, the membrane separation apparatus further includes a first flowrate measurer configured to measure a flowrate value of the permeated water, and the pump controller is configured to perform feedback control using the flowrate value of the permeated water as a feedback value.

Preferably, the membrane separation apparatus further includes a second flowrate measurer configured to measure a value of the drainage water flowrate, and the drainage water flowrate regulation valve controller is configured to perform feedback control using the value of the drainage water flowrate as a feedback value.

Preferably, at the time of supplying water to the membrane separation apparatus, the pump controller is configured to decrease the rotational speed of the booster pump, the intake water pressure regulation valve controller is configured to increase the opening degree of the intake water pressure regulation valve or fully open the intake water pressure regulation valve, and when the rotational speed is decreased and consequently becomes lower than a predetermined value, the intake water pressure regulation valve controller decreases the opening degree of the intake water pressure regulation valve.

According to the aspect of the invention, lives of the opening-degree adjustable valves can be lengthened, and various kinds of PI control can be stabilized.

The foregoing and other object, features, aspects, and advantages of the invention will become more apparent from the following detailed description of the invention when taken in conjunction with the accompanying drawings.

### BRIEF DESCRIPTION OF THE DRAWINGS

FIG. 1 is a diagram illustrating the general arrangement of a membrane separation apparatus according to an embodiment of the invention.

FIG. 2 is a graph illustrating a relationship between a pressure and a flowrate concerning a flowrate regulation unit used in a first embodiment of the invention.

FIG. 3 is a function block diagram illustrating a controller of the membrane separation apparatus according to the embodiment of the invention.

FIG. 4 is a table illustrating exemplary control sequences of components that constitute the membrane separation apparatus according to the embodiment of the invention.

FIG. 5 is a table illustrating the exemplary control sequences of the components of the membrane separation apparatus according to the embodiment of the invention, and changes in pressures, flowrates, and a recovery rate.

### DETAILED DESCRIPTION OF THE INVENTION

### 1. CONFIGURATION OF MEMBRANE SEPARATION APPARATUS

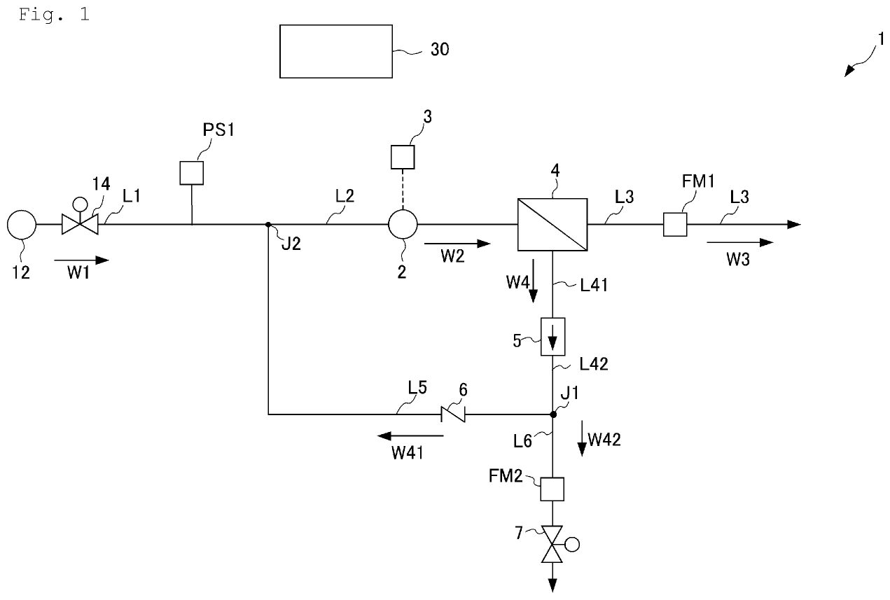

A membrane separation apparatus 1 according to an embodiment of the invention will be described with reference to the accompanying drawings. FIG. 1 is a diagram illustrating the general arrangement of the membrane separation apparatus 1 according to the embodiment of the invention.

As illustrated in FIG. 1, the membrane separation apparatus 1 according to this embodiment includes a feed pump 12, a booster pump 2, a booster-side inverter 3, an RO membrane module 4 as a reverse osmosis membrane module, a flowrate regulation unit 5, a check valve 6, a drainage water flowrate regulation valve 7 as a drainage water flowrate regulator, an intake water pressure regulation valve 14, an intake water pressure sensor PS1, a first flowrate sensor FM1, a second flowrate sensor FM2, and a controller 30. In FIG. 1, illustration of electrical connection lines between the controller 30 and components to be controlled is omitted.

The membrane separation apparatus 1 also includes an intake water line L1, a feedwater line L2, a permeated water line L3, a concentrated water line L4, a circulation water line L5, and a drainage water line L6. In this specification, the term “line” generally refers to a line where a fluid is flowable, such as passages, channels, and piping.

The intake water line L1 is a line to supply intake water W1 to a junction J2 to join the feedwater line L2. An upstream end of the intake water line L1 is connected to a supply source (not illustrated) of the intake water W1. In the intake water line L1, the feed pump 12, the intake water pressure regulation valve 14, the intake water pressure sensor PS1, and the junction J2 are disposed in sequence from an upstream side to a downstream side.

It should be noted that the intake water W1 flowing through the intake water line L1 includes not only raw water directly supplied from the supply source (not illustrated) of the intake water W1 but also preprocessed water, which is raw water preprocessed by a preprocessor, such as a filtration device (e.g., an iron and manganese removal device and an activated carbon filter), and a water softening device.

The feed pump 12 is a device to take in the intake water W1 that flows through the intake water line L1 and to send (discharge) the intake water W1 under pressure to the booster pump 2. The feed pump 12 is driven at a rotational speed in accordance with a frequency of supplied (input) drive power (hereinafter also referred to as “drive frequency”).

The intake water pressure regulation valve 14 is a valve to regulate a pressure of the intake water W1 that flows through the intake water line L1. The intake water pressure regulation valve 14 is electrically connected to the controller 30. An opening degree of the intake water pressure regulation valve 14 is controlled by the controller 30. The intake water pressure regulation valve 14 may be, for example, a solenoid valve.

The intake water pressure sensor PS1 measures a pressure of the intake water W1 that flows through the intake water line L1. The intake water pressure sensor PS1 is electrically connected to the controller 30. The pressure of the intake water W1 measured by the intake water pressure sensor PS1 is transmitted as a detection signal to the controller 30.

The feedwater line L2 is a line to feed the intake water W1 as feedwater W2 to the RO membrane module 4. An upstream end of the feedwater line L2 is connected to the junction J2. A downstream end of the feedwater line L2 is connected to a primary inlet port of the RO membrane module 4. In the feedwater line L2, the junction J2, the booster pump 2, and the RO membrane module 4 are disposed in sequence from an upstream side to a downstream side.

The booster pump 2 is disposed in the feedwater line L2. The booster pump 2 is a device to take in the intake water W1 and feed (discharge) the intake water W1 as the feedwater W2 under pressure to the RO membrane module 4 in the feedwater line L2. Drive power having a converted frequency is supplied from the booster-side inverter 3 to the booster pump 2. The booster pump 2 is driven at a rotational speed in accordance with the frequency of supplied (input) drive power (hereinafter also referred to as “drive frequency”).

The booster-side inverter 3 is an electric circuit (or a device including the electric circuit) to supply drive power having a converted frequency to the booster pump 2. The booster-side inverter 3 is electrically connected to the controller 30. A command signal is input from the controller 30 to the booster-side inverter 3. The booster-side inverter 3 outputs drive power having a drive frequency corresponding to a command signal (a current value signal or a voltage value signal) input from the controller 30.

The RO membrane module 4 is a device for membrane separation processing to separate the feedwater W2 discharged from the booster pump 2 into permeated water W3 with dissolved salts removed and concentrated water W4 with the dissolved salts concentrated. The RO membrane module 4 includes a single RO membrane element or a plurality of RO membrane elements (not illustrated). The RO membrane module 4 causes these RO membrane elements to subject the feedwater W2 to the membrane separation processing to produce the permeated water W3 and the concentrated water W4.

The permeated water line L3 is a line to send the permeated water W3 separated by the RO membrane module 4. An upstream end of the permeated water line L3 is connected to a secondary port of the RO membrane module 4. A downstream end of the permeated water line L3 is connected to a device in demand, for example. The first flowrate sensor FM1 (hereinafter also referred to as “first flowrate detector”) is disposed in the permeated water line L3.

The first flowrate sensor FM1 is a device to detect, as a first detection flowrate value, a flowrate of the permeated water W3 that flows through the permeated water line L3. The first flowrate sensor FM1 is connected to the permeated water line L3. The first flowrate sensor FM1 is electrically connected to the controller 30. The first detection flowrate value of the permeated water W3 that has been detected by the first flowrate sensor FM1 is transmitted to the controller 30 as a detection signal. As the first flowrate sensor FM1, for example, a pulse-oscillation flowrate sensor with an axial-flow vane wheel or a tangential vane wheel (not illustrated) disposed in a passage housing may be employed.

A first concentrated water line L41 is a line to send the concentrated water W4 separated by the RO membrane module 4. An upstream end of the first concentrated water line L41 is connected to a primary outlet port of the RO membrane module 4. A downstream end of the first concentrated water line L41 is connected to a primary side of the flowrate regulation unit 5.

A second concentrated water line L42 is a line to send the concentrated water W4 having a flowrate regulated by the flowrate regulation unit 5. An upstream end of the second concentrated water line L42 is connected to a secondary side of the flowrate regulation unit 5. A downstream side of the second concentrated water line L42 diverges into the circulation water line L5 and the drainage water line L6 at a joint J1.

Hereinafter, the first concentrated water line L41 and the second concentrated water line L42 will be collectively referred to as “concentrated water line L4” on occasion.

The flowrate regulation unit 5 includes a constant flowrate element and a proportional element. The constant flowrate element causes the concentrated water W4 to flow at a substantially constant flowrate irrespective of a differential pressure in the flowrate regulation unit 5. The proportional element increases a flowrate of the concentrated water W4 substantially in proportion to the differential pressure in the flowrate regulation unit 5. Specifically, the differential pressure in the flowrate regulation unit 5 is a difference between a water pressure in the first concentrated water line L41 and a water pressure in the second concentrated water line L42. As the constant flowrate element, a device that maintains a constant flowrate value without requiring auxiliary power and external operation and that is called a water governor, for example, may be employed. As the proportional element, a device called an orifice, for example, may be employed. A flowrate of the concentrated water W4 flowing from the orifice is in proportion to the differential pressure in the flowrate regulation unit 5.

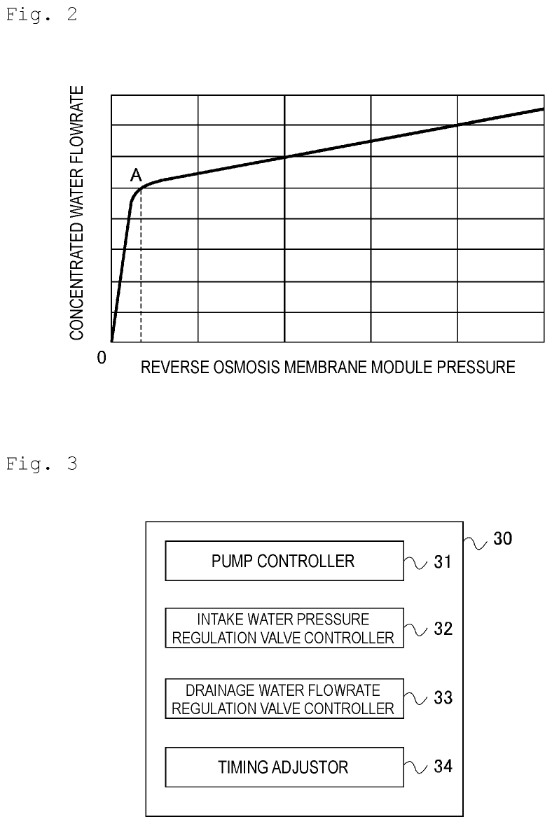

FIG. 2 is a graph of an exemplary relationship between an inlet pressure of the RO membrane module 4 and a flowrate of the concentrated water W4 flowing in the flowrate regulation unit 5. Since the flowrate regulation unit 5 includes the constant flowrate element, the flowrate of the concentrated water W4 flowing in the flowrate regulation unit 5 sharply increases to a point A when the inlet pressure is generated. That is, approximately, at the same time as generation of the inlet pressure, the concentrated water W4 at the flowrate as high as the point A flows into the flowrate regulation unit 5. Because the flowrate regulation unit 5 also includes the proportional element, the flowrate of the concentrated water W4 flowing in the flowrate regulation unit 5 subsequently increases in a linear function manner as the inlet pressure increases.

It should be noted that in the flowrate regulation unit 5, the constant flowrate element and the proportional element may be integrally provided or provided as separate members. When the constant flowrate element and the proportional element are integrally provided, for example, a flow direction of the proportional element may coincide with a longitudinal axis direction of the flowrate regulation unit 5, and a flow direction of the constant flowrate element may be perpendicular to the longitudinal axis direction of the flowrate regulation unit 5. Alternatively, the flow direction of the proportional element may be perpendicular to the longitudinal axis direction of the flowrate regulation unit 5, and the flow direction of the constant flowrate element may coincide with the longitudinal axis direction of the flowrate regulation unit 5. Alternatively, both of the flow direction of the constant flowrate element and the flow direction of the proportional element may coincide with the longitudinal axis direction of the flowrate regulation unit 5.

The circulation water line L5 diverges from the concentrated water line L4 and is a line to return circulation water W41 to the junction J2. The circulation water W41 is part of the concentrated water W4 separated by the RO membrane module 4. An upstream end of the circulation water line L5 is connected to the concentrated water line L4 at the joint J1. A downstream end of the circulation water line L5 is connected to the intake water line L1 at the junction J2. The check valve 6 is disposed in the circulation water line L5.

The drainage water line L6 diverges from the concentrated water line L4 at the joint J1 and is a line to drain drainage water W42 from the apparatus (out of the system). The drainage water W42 is the rest of the concentrated water W4 separated by the RO membrane module 4. In the drainage water line L6, the second flowrate sensor FM2 (hereinafter also referred to as “second flowrate detector”) and the drainage water flowrate regulation valve 7 as a drainage water flowrate regulator are disposed from an upstream side to a downstream side.

The second flowrate sensor FM2 is a device to detect, as a second detection flowrate value, a drainage water flowrate of the drainage water W42 to be drained from the apparatus via the drainage water line L6. The second flowrate sensor FM2 is connected to the drainage water line L6. The second flowrate sensor FM2 is electrically connected to the controller 30. The second detection flowrate value of the drainage water W42 that has been detected by the second flowrate sensor FM2 is transmitted to the controller 30 as a detection signal. As the second flowrate sensor FM2, for example, a pulse-oscillation flowrate sensor with an axial-flow vane wheel or a tangential vane wheel (not illustrated) disposed in a passage housing may be employed.

The drainage water flowrate regulation valve 7 is capable of regulating the drainage water flowrate of the drainage water W42 to be drained from the apparatus via the drainage water line L6. The drainage water flowrate regulation valve 7 is electrically connected to the controller 30. A valve opening degree of the drainage water flowrate regulation valve 7 is controlled in accordance with a drive signal transmitted from the controller 30. The controller 30 transmits a current value signal (e.g., 4 mA to 20 mA) to the drainage water flowrate regulation valve 7 and controls the valve opening degree to regulate the drainage water flowrate of the drainage water W42. The drainage water flowrate regulation valve 7 may be, for example, a solenoid valve.

### 2. FUNCTION BLOCKS OF CONTROLLER

The controller 30 includes components such as a CPU, a ROM, a RAM, and a CMOS memory, which are communicable with one another via buses, and is known to those skilled in the art.

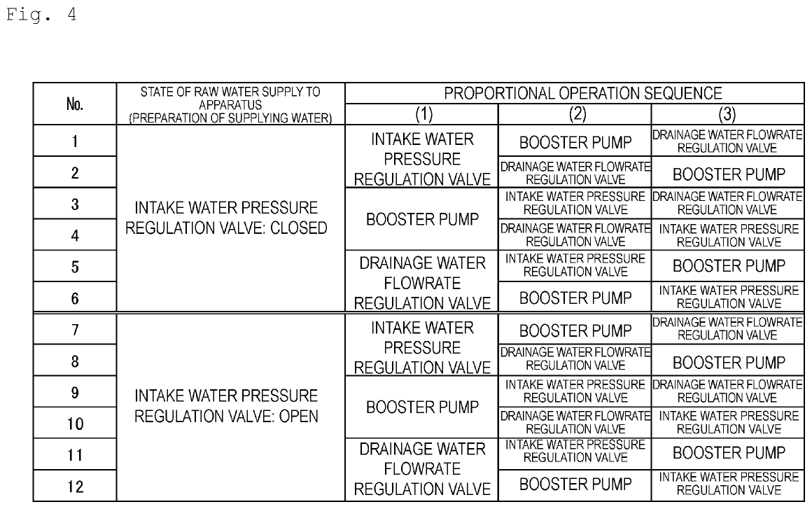

The CPU is a processor to totally control the membrane separation apparatus 1. The CPU reads various kinds of programs stored in the ROM via the buses and controls the whole membrane separation apparatus 1 in accordance with the various kinds of programs. Consequently, as illustrated in a function block diagram of FIG. 3, the controller 30 implements functions of a pump controller 31, an intake water pressure regulation valve controller 32, a drainage water flowrate regulation valve controller 33, and a timing adjustor 34. The RAM stores various kinds of data, such as temporary calculation data and display data. The CMOS memory is a non-volatile memory, which is backed up by a battery (not illustrated) and retains a memory state even when the membrane separation apparatus 1 is powered off.

The pump controller 31 controls the rotational speed of the booster pump 2. More specifically, the pump controller 31 controls a frequency of the booster pump 2 via the booster-side inverter 3 so as to regulate a flowrate of the feedwater W2 discharged by the booster pump 2. The pump controller 31 may perform feedback control using a flowrate value of the permeated water W3 detected by the first flowrate sensor FM1.

The intake water pressure regulation valve controller 32 controls the opening degree of the intake water pressure regulation valve 14. In particular, in accordance with a timing adjusted by the timing adjustor 34, described later, the intake water pressure regulation valve controller 32 controls the opening degree of the intake water pressure regulation valve 14. The intake water pressure regulation valve controller 32 may perform feedback control using a pressure value of the intake water W1 detected by the intake water pressure sensor PS1.

The drainage water flowrate regulation valve controller 33 controls the opening degree of the drainage water flowrate regulation valve 7. In particular, in accordance with a timing adjusted by the timing adjustor 34, described later, the drainage water flowrate regulation valve controller 33 controls the opening degree of the drainage water flowrate regulation valve 7. The drainage water flowrate regulation valve controller 33 may perform feedback control using a flowrate value of the drainage water W42 detected by the second flowrate sensor FM2.

The timing adjustor 34 adjusts timings of control by the pump controller 31, the intake water pressure regulation valve controller 32, and the drainage water flowrate regulation valve controller 33. In particular, at the time of supplying water to the membrane separation apparatus 1, the booster pump 2, the intake water pressure regulation valve 14, and the drainage water flowrate regulation valve 7 that are operated at once affect one another so that phenomena may occur, such as hunting and increases in the number of operations of the intake water pressure regulation valve 14 and the drainage water flowrate regulation valve 7. In view of this, to prevent hunting and decrease the number of operations of the intake water pressure regulation valve 14 and the drainage water flowrate regulation valve 7, the timing adjustor 34 provides time lags among a control start timing of the booster pump 2 by the pump controller 31, a control start timing of the intake water pressure regulation valve 14 by the intake water pressure regulation valve controller 32, and a control start timing of the drainage water flowrate regulation valve 7 by the drainage water flowrate regulation valve controller 33 at the time of supplying water to the membrane separation apparatus 1. The time lags are set considering factors, such as time until the intake water pressure is stabilized, a maximum frequency of the booster pump 2, and operation time of the intake water pressure regulation valve 14 and the drainage water flowrate regulation valve 7.

At the time of supplying water to the membrane separation apparatus 1, the timing adjustor 34 provides time lags among the control start timing of the booster pump 2 by the pump controller 31, the control start timing of the intake water pressure regulation valve 14 by the intake water pressure regulation valve controller 32, and the control start timing of the drainage water flowrate regulation valve 7 by the drainage water flowrate regulation valve controller 33. This results in six possible control sequences in controlling the booster pump 2, the intake water pressure regulation valve 14, and the drainage water flowrate regulation valve 7. Furthermore, considering whether to close the intake water pressure regulation valve 14 at a preparatory stage of supplying water to the membrane separation apparatus 1 or whether to open the intake water pressure regulation valve 14 itself while the passage can be opened and closed by an ON-OFF valve upstream of the intake water pressure regulation valve 14, twelve control sequences are possible.

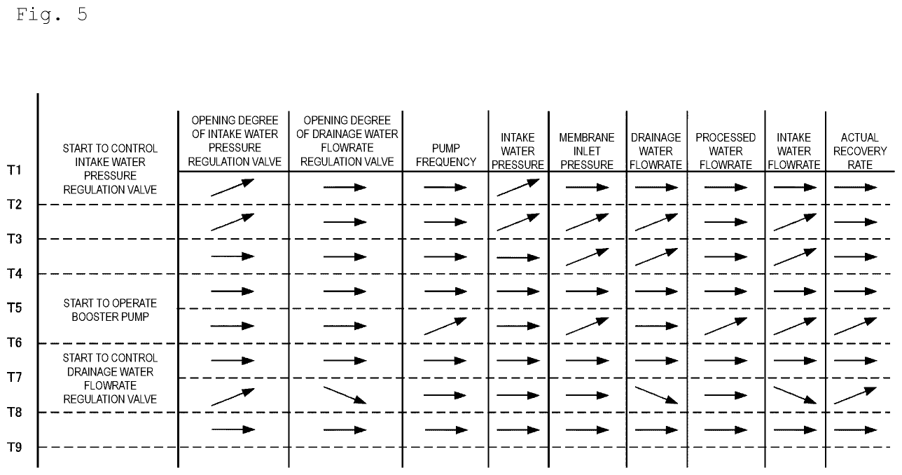

FIG. 4 is a table illustrating these twelve control sequences.

Referring to the table of FIG. 4, as illustrated in the row No. 1, suppose that the intake water pressure regulation valve 14 is first operated, that the booster pump 2 is operated next, and that the drainage water flowrate regulation valve 7 is finally operated. In this case, after the booster pump 2 is operated and when the intake water pressure is stabilized, the opening degree of the drainage water flowrate regulation valve 7 is adjusted so that unstable operation is less likely to occur.

As illustrated in the row No. 2, suppose that the intake water pressure regulation valve 14 is first operated, that the drainage water flowrate regulation valve 7 is operated next, and that the booster pump 2 is finally operated. In this case, when the booster pump 2 is operated, the intake water pressure decreases. Accordingly, the opening degree of the drainage water flowrate regulation valve 7 that has been adjusted once is to be readjusted so that the intake water pressure regulation valve 14 and the drainage water flowrate regulation valve 7 are operated at once to make hunting more liable to occur. Depending upon follow-up performance of the drainage water flowrate regulation valve 7, the drainage water flowrate may exceed a target drainage water flowrate, which may cause an amount of water supplied to the membrane separation apparatus 1 to exceed an allowable supplied water amount.

Control sequences illustrated in the rows Nos. 3 to 6 are inoperable modes in which the intake water pressure regulation valve 14 is not operated at a control start, and no water is supplied to the membrane separation apparatus 1.

In a control sequence illustrated in the row No. 7, adjustment of the intake water pressure regulation valve 14 is first performed to make the intake water pressure a target intake water pressure. Then, in a similar manner to the mode illustrated in the row No. 1, after the booster pump 2 is operated and when the intake water pressure is stabilized, the opening degree of the drainage water flowrate regulation valve 7 is adjusted so that unstable operation is less likely to occur.

In a control sequence illustrated in the row No. 8 as well, adjustment of the intake water pressure regulation valve 14 is first performed to make the intake water pressure the target intake water pressure. Then, in a similar manner to the mode illustrated in the row No. 2, when the booster pump 2 is operated, the intake water pressure decreases. Accordingly, the opening degree of the drainage water flowrate regulation valve 7 that has been initially adjusted is to be readjusted so that the intake water pressure regulation valve 14 and the drainage water flowrate regulation valve 7 are operated at once to make hunting more liable to occur. Depending upon follow-up performance of the drainage water flowrate regulation valve 7, the drainage water flowrate may exceed a target drainage water flowrate, which may cause the amount of water supplied to the membrane separation apparatus 1 to exceed the allowable supplied water amount.

In a control sequence illustrated in the row No. 9, after operating the booster pump 2, adjustment of the intake water pressure regulation valve 14 is performed to make the intake water pressure a target intake water pressure. Since operation of the booster pump 2 causes the intake water pressure to change moment by moment to make operation more liable to be unstable. During this time, because a time lag is set, the drainage water flowrate regulation valve 7 is not operated so that an intake water amount may exceed an allowable intake water amount, and that excessive concentration may occur.

In a control sequence illustrated in the row No. 10, after starting to operate the drainage water flowrate regulation valve 7, operation of the intake water pressure regulation valve 14 is started with the drainage water flowrate regulation valve 7 kept operated so as to regulate the intake water pressure. Thus, all the components to be controlled are operated at once to make hunting more liable to occur.

In a control sequence illustrated in the row No. 11, after adjusting the opening degrees of the drainage water flowrate regulation valve 7 and the intake water pressure regulation valve 14, the booster pump 2 is operated so that readjustment of the opening degrees of the drainage water flowrate regulation valve 7 and the intake water pressure regulation valve 14 will be needed and take more time until operation is stabilized.

In a control sequence illustrated in the row No. 12, after starting to operate the drainage water flowrate regulation valve 7, operation of the intake water pressure regulation valve 14 is started with the drainage water flowrate regulation valve 7 kept operated. Thus, in operating the intake water pressure regulation valve 14, all the components to be controlled are operated at once to make hunting more liable to occur.

That is, according to this embodiment, to prevent hunting and decrease the number of operations by the intake water pressure regulation valve 14 and the drainage water flowrate regulation valve 7, preferably, control of the intake water pressure regulation valve 14 is started first. More preferably, after starting to control the intake water pressure regulation valve 14 first, control of the booster pump 2 is started next, and finally, control of the drainage water flowrate regulation valve 7 is started.

At the time of supplying water to the membrane separation apparatus 1, the pump controller 31 decreases the rotational speed (frequency) of the booster pump 2, and the intake water pressure regulation valve controller 32 increases the opening degree of the intake water pressure regulation valve 14 or fully opens the intake water pressure regulation valve 14. When the rotational speed is decreased and consequently becomes lower than a predetermined value, the intake water pressure regulation valve controller 32 may decrease the opening degree of the intake water pressure regulation valve 14.

When the frequency of the booster pump 2 becomes lower than a predetermined value, the booster pump 2 is not cooled enough. This makes it necessary to set a minimum frequency of the booster pump 2 in operation. When the frequency of the booster pump 2 becomes lower than the minimum frequency in operation, the opening degree of the intake water pressure regulation valve 14 is gradually decreased to enable such control as to prevent, to the utmost, the frequency of the booster pump 2 from becoming lower than the minimum frequency in operation.

### 3. EXAMPLES

FIG. 5 is a table illustrating operation examples of the membrane separation apparatus 1 according to this embodiment. More specifically, the table of FIG. 5 illustrates changes in the opening degree of the intake water pressure regulation valve 14, the opening degree of the drainage water flowrate regulation valve 7, and control details of the frequency of the booster pump 2. The table of FIG. 5 also illustrates changes in the intake water pressure, a membrane inlet pressure, the drainage water flowrate, a processed water flowrate (the flowrate of the permeated water W3), and an actual recovery rate in accordance with those changes. An arrow slanting upward to the right, an arrow straight to the right, and an arrow slanting downward to the right respectively represent increasing, constant, and decreasing. It should be noted that in this table, the “actual recovery rate” refers to a rate of a flowrate of the feedwater W2 to the processed water flowrate (the flowrate of the permeated water W3). The flowrate of the feedwater W2 is calculated from the sum of the drainage water flowrate and the processed water flowrate (the flowrate of the permeated water W3). In the table of FIG. 5, time elapses from an upper row to a lower row.

As illustrated in FIG. 5, according to this embodiment, after starting to control the intake water pressure regulation valve 14 at timing T1, operation of the booster pump 2 is started at timing T5, and finally, control of the drainage water flowrate regulation valve 7 is started at timing T7.

At timing T1, control of the intake water pressure regulation valve 14 is started. This causes the opening degree of the intake water pressure regulation valve 14 to increase between timing T1 and timing T2 to increase the intake water pressure whereas other attribute values are not changed. In particular, no change is found in the membrane inlet pressure because the intake water pressure is not high enough.

Between timing T2 and timing T3, in addition to the increase in the intake water pressure, the membrane inlet pressure increases to raise the drainage water flowrate and the intake water flowrate.

Between timing T3 and timing T4, the opening degree of the intake water pressure regulation valve 14 is kept constant. This makes the intake water pressure constant in a manner different from the period between timing T1 and timing T2.

Between timing T4 and timing T5, the membrane inlet pressure, the drainage water flowrate, and the intake water flowrate that have been increasing between timing T3 and timing T4 are made constant.

At timing T5, operation of the booster pump 2 is started. This causes the pump frequency of the booster pump 2 to increase between timing T5 and timing T6 to increase the membrane inlet pressure so as to raise the processed water flowrate and the intake water flowrate. Thus, the actual recovery rate is increased.

Between timing T6 and timing T7, the pump frequency of the booster pump 2 is made constant. This causes the membrane inlet pressure that has been increasing between timing T5 and timing T6 to be constant, and the processed water flowrate and the intake water flowrate that have been raised to be constant. Consequently, the actual recovery rate becomes constant.

At timing T7, control of the drainage water flowrate regulation valve 7 is started. This causes the opening degree of the drainage water flowrate regulation valve 7 to decrease between timing T7 and timing T8 to lower the drainage water flowrate and the intake water flowrate. Thus, the actual recovery rate is increased.

Between timing T8 and timing T9, the opening degree of the drainage water flowrate regulation valve 7 is made constant. This causes the drainage water flowrate and the intake water flowrate that have been lowered between timing T7 and timing T8 and the actual recovery rate to be constant.

### 4. EFFECTS OF THIS EMBODIMENT

The membrane separation apparatus 1 according to the above-described embodiment can provide the following effects, for example.

The membrane separation apparatus 1 includes the pump controller 31, the intake water pressure regulation valve 14, the drainage water flowrate regulation valve 7, the intake water pressure regulation valve controller 32, the drainage water flowrate regulation valve controller 33, and the timing adjustor 34. The pump controller 31 controls the rotational speed of the booster pump 2. The intake water pressure regulation valve 14 has the opening degree substantially steplessly adjusted to regulate the pressure of the intake water W1 supplied to the booster pump 2. The drainage water flowrate regulation valve 7 has the opening degree substantially steplessly adjusted to regulate the drainage water flowrate of the concentrated water W4 to be drained from the apparatus. The intake water pressure regulation valve controller 32 controls the opening degree of the intake water pressure regulation valve 14. The drainage water flowrate regulation valve controller 33 controls the opening degree of the drainage water flowrate regulation valve 7. The timing adjustor 34 adjusts the timings of control by the pump controller 31, the intake water pressure regulation valve controller 32, and the drainage water flowrate regulation valve controller 33. The timing adjustor 34 provides time lags among the control start timing of the booster pump 2 by the pump controller 31, the control start timing of the intake water pressure regulation valve 14 by the intake water pressure regulation valve controller 32, and the control start timing of the drainage water flowrate regulation valve 7 by the drainage water flowrate regulation valve controller 33 at the time of supplying water to the membrane separation apparatus 1.

The control start timings of the booster pump 2, the intake water pressure regulation valve 14, and the drainage water flowrate regulation valve 7 are deviated from one another to decrease a possibility of hunting. Moreover, this decreases time until the flowrates are stabilized.

At the time of supplying water to the membrane separation apparatus 1, after starting to control the intake water pressure regulation valve 14, the timing adjustor 34 causes the pump controller 31 to start to control the booster pump 2 or causes the drainage water flowrate regulation valve controller 33 to start to control the drainage water flowrate regulation valve 7.

When control of the booster pump 2 is started first, the booster pump 2 is to be controlled again after starting to control the intake water pressure regulation valve 14. By starting to control the intake water pressure regulation valve 14 first, such complicated control can be avoided.

At the time of supplying water to the membrane separation apparatus 1, after starting to control the intake water pressure regulation valve 14, the timing adjustor 34 causes the pump controller 31 to start to control the booster pump 2, and after starting to control the booster pump 2, the timing adjustor 34 causes the drainage water flowrate regulation valve controller 33 to start to control the drainage water flowrate regulation valve 7.

When the intake water pressure regulation valve 14 is opened after closing the drainage water flowrate regulation valve 7, there is a possibility of increasing the recovery rate. More specifically, when the drainage water flowrate regulation valve 7 is operated first, the subsequent operation of the booster pump 2 changes the intake water pressure. Thus, the intake water pressure regulation valve 14 and the drainage water flowrate regulation valve 7 are operated at once and may cause hunting and exceeding the allowable intake water amount. After starting to control the intake water pressure regulation valve 14, the booster pump 2 is operated, and after the intake water pressure is stabilized, the drainage water flowrate regulation valve 7 is controlled so that stable operation can be implemented without exceeding an allowable recovery rate.

The membrane separation apparatus 1 further includes the intake water pressure sensor PS1 to measure a pressure value of the intake water W1. The intake water pressure regulation valve controller 32 performs feedback control using the pressure value of the intake water W1 as a feedback value.

When the intake water pressure is not kept constant, an inverter of the booster pump 2 and the drainage water flowrate regulation valve 7 are operated in accordance with a change in the intake water pressure so frequently that hunting is more liable to occur. Moreover, depending upon the follow-up performance, exceeding the allowable supplied water amount and increasing the recovery rate may occur. When the intake water pressure regulation valve 14 is controlled using the pressure value of the intake water W1 as a feedback value, the pressure value of the intake water W1 is kept constant so that the possibility of hunting can be decreased. Furthermore, possibilities of exceeding the allowable supplied water amount and excessive concentration can be decreased. The drainage water flowrate regulation valve 7 has a type capable of continuous operation and a type incapable of continuous operation. In the case of requiring frequent control of the drainage water flowrate regulation valve 7, the type incapable of continuous operation cannot be employed. However, by keeping the pressure of the intake water W1 constant, the drainage water flowrate regulation valve 7 of the type incapable of continuous operation can be used.

The membrane separation apparatus 1 further includes the first flowrate sensor FM1 to measure a flowrate value of the permeated water W3. The pump controller 31 performs feedback control using the flowrate value of the permeated water W3 as a feedback value.

Regulation to make the permeated water amount a target permeated water amount prevents the permeated water amount from changing due to a water temperature change so that the flowrate can be kept constant.

The membrane separation apparatus 1 further includes the second flowrate sensor FM2 to measure a drainage water flowrate value. The drainage water flowrate regulation valve controller 33 performs feedback control using the drainage water flowrate value as a feedback value.

Regulation to make the drainage water flowrate a target drainage water flowrate enables operation with a recovery rate as close as possible to a set recovery rate.

At the time of supplying water to the membrane separation apparatus 1, the pump controller 31 decreases the rotational speed of the booster pump 2, and the intake water pressure regulation valve controller 32 increases the opening degree of the intake water pressure regulation valve 14 or fully opens the intake water pressure regulation valve 14. When the rotational speed is decreased and consequently becomes lower than the predetermined value, the intake water pressure regulation valve controller 32 decreases the opening degree of the intake water pressure regulation valve 14.

The rotational speed of the booster pump 2 is decreased, and the opening degree of the intake water pressure regulation valve 14 is increased or the intake water pressure regulation valve 14 is fully opened so that a raw water pressure can be utilized to the maximum to implement energy saving operation.

### 5. MODIFICATION

In the above-described embodiment, the membrane separation apparatus 1 is an RO membrane apparatus including the RO membrane module 4. This, however, should not be construed in a limiting sense. The membrane separation apparatus 1 may be, for example, an NF (loose RO) membrane apparatus.

Various modifications and alterations of the invention will be apparent to those skilled in the art without departing from the scope and spirit of the invention, and it should be understood that this is not limited to the illustrative embodiments set forth herein.

What is claimed is:

1. A membrane separation apparatus comprising:
a reverse osmosis membrane module configured to separate feedwater comprising intake water into permeated water and concentrated water;
a booster pump configured to take in the intake water and discharge the intake water as the feedwater to the reverse osmosis membrane module;
a pump controller configured to control a rotational speed of the booster pump;
an intake water pressure regulation valve comprising an opening degree substantially steplessly adjusted to regulate a pressure of the intake water supplied to the booster pump;
a drainage water flowrate regulation valve comprising an opening degree substantially steplessly adjusted to regulate a drainage water flowrate of the concentrated water to be drained from the apparatus,
an intake water pressure regulation valve controller configured to control the opening degree of the intake water pressure regulation valve;
a drainage water flowrate regulation valve controller configured to control the opening degree of the drainage water flowrate regulation valve; and
a timing adjustor configured to adjust timings of control by the pump controller, the intake water pressure regulation valve controller, and the drainage water flowrate regulation valve controller,
wherein at a time of supplying water to the membrane separation apparatus, the timing adjustor is configured to provide time lags among a control start timing of the booster pump by the pump controller, a control start timing of the intake water pressure regulation valve by the intake water pressure regulation valve controller, and a control start timing of the drainage water flowrate regulation valve by the drainage water flowrate regulation valve controller.

2. The membrane separation apparatus according to claim 1, wherein at the time of supplying water to the membrane separation apparatus, after starting to control the intake water pressure regulation valve, the timing adjustor is configured to cause the pump controller to start to control the booster pump or configured to cause the drainage water flowrate regulation valve controller to control the drainage water flowrate regulation valve.

3. The membrane separation apparatus according to claim 2, wherein at the time of supplying water to the membrane separation apparatus, the timing adjustor is configured to cause the pump controller to start to control the booster pump after starting to control the intake water pressure regulation valve, and configured to cause the drainage water flowrate regulation valve controller to control the drainage water flowrate regulation valve after starting to control the booster pump.

4. The membrane separation apparatus according to claim 1, further comprising a pressure measurer configured to measure a pressure value of the intake water,
wherein the intake water pressure regulation valve controller is configured to perform feedback control using the pressure value of the intake water as a feedback value.

5. The membrane separation apparatus according to claim 1, further comprising a first flowrate measurer configured to measure a flowrate value of the permeated water,
wherein the pump controller is configured to perform feedback control using the flowrate value of the permeated water as a feedback value.

6. The membrane separation apparatus according to claim 1, further comprising a second flowrate measurer configured to measure a value of the drainage water flowrate,
wherein the drainage water flowrate regulation valve controller is configured to perform feedback control using the value of the drainage water flowrate as a feedback value.

7. The membrane separation apparatus according to claim 1, wherein at the time of supplying water to the membrane separation apparatus, the pump controller is configured to decrease the rotational speed of the booster pump, the intake water pressure regulation valve controller is configured to increase the opening degree of the intake water pressure regulation valve or fully open the intake water pressure regulation valve, and when the rotational speed is decreased and consequently becomes lower than a predetermined value, the intake water pressure regulation valve controller decreases the opening degree of the intake water pressure regulation valve.
